(19) United States
(12) Patent Application Publication
(10) Pub. No.: US 2016/0307696 A1
(43) Pub. Date: Oct. 20, 2016

(54) MAGNET MANUFACTURING METHOD AND MAGNET

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/094,228

(22) Filed: Apr. 8, 2016

(30) Foreign Application Priority Data
Apr. 16, 2015 (JP) 2015-084011

(51) Int. Cl. H01F 41/02; H01F 7/02; B22F 3/16; B22F 5/00; C22C 38/00; B22F 1/00

(52) U.S. Cl. CPC H01F 41/0266; C22C 38/005; C22C 38/001; B22F 1/0059; B22F 3/16; B22F 5/00; H01F 7/021; B22F 2301/355; B22F 2302/20

(57) ABSTRACT

A magnet manufacturing method has preparing magnetic powder of a hard magnetic material, which includes one or more of an Fe-N-based compound and an R-Fe-N-based compound, pressurizing and molding the magnetic powder at a pressure equal to or higher than a fracture pressure at which particles of the magnetic powder are destroyed in order to obtain a primary molding, and heating the primary molding at a temperature lower than a decomposition temperature of the magnetic powder. A particle size distribution measured for the magnetic powder indicates that, for the magnetic powder, a ratio of a particle size with a cumulative frequency of 50% to a particle size with a cumulative frequency of 3% is less than eight.

### INCORPORATION BY REFERENCE

The disclosure of Japanese Patent Application No. 2015-084011 filed on Apr. 16, 2015 including the specification, drawings and abstract, is incorporated herein by reference in its entirety.

### BACKGROUND OF THE INVENTION

1. Field of the Invention

The invention relates to a magnet manufacturing method and a magnet.

2. Description of Related Art

Japanese Patent Application Publication No. 2007-39794 (JP 2007-39794 A) describes a magnet containing an Nd-Fe-B alloy or an Sm-Fe-N alloy. JP 2007-39794 further discloses that a soft magnetic metal is mixed with the above-described alloy and that the mixture is molded under pressure and sintered.

Japanese Patent Application Publication No. 2012-69962 (JP 2012-69962 A) discloses that an R-Fe-N-H-based magnetic material and soft magnetic powder are mixed together and that the mixture is compacted and solidified by impact compression using an underwater shock wave and that after the impact compression, a residual temperature is kept equal to or lower than a decomposition temperature of the magnetic material. This magnet contains no binder such as resin.

Japanese Patent Application Publication No. 2005-223263 (JP 2005-223263 A) discloses that a rare-earth permanent magnet is manufactured by forming an oxide film on Sm-Fe-N-based compound powder, then preliminarily compression-molding the Sm-Fe-N-based compound powder into a predetermined shape in a non-oxidizing atmosphere, and compacting the resultant compound at 350 to 500° C. in the non-oxidizing atmosphere. JP 2005-223263 discloses that the Sm-Fe-N-based magnet can thus be manufactured at a temperature lower than the decomposition temperature.

Japanese Patent Application Publication No. S62-206801 (JP S62-206801 A) discloses that a stearic acid is mixed with alloy powder to cover powder particles with the stearic acid and that the powder particles are then compression-molded and then sintered.

Japanese Patent Application Publication No. 2015-8200 (JP 2015-8200 A) discloses that a magnet is manufactured by executing a pressurizing step of forming a primary molding by pressurizing magnetic powder of a hard magnetic material a plurality of times using a mold, the magnetic powder being formed using an R-Fe-N-based compound containing a rare earth element as R or an Fe-N-based compound, and then forming a secondary molding by heating the magnetic powder at a temperature lower than the decomposition temperature of the magnetic powder to join surfaces of adjacent magnetic particles.

In JP 2007-39794 A and JP S62-206801 A, dysprosium (Dy), which is expensive and rare, needs to be used for the magnet containing the Nd-Fe-B alloy. When the Sm-Fe-N alloy is used, sintering is difficult due to the low decomposition temperature of the Sm-Fe-N alloy. The sintering involves temperatures equal to or higher than the decomposition temperature, leading to decomposition of the alloy to preclude the resultant magnet from demonstrating its performance as a magnet. Thus, Sm-Fe-N-based magnets are typically joined together with a bond such as resin. However, the use of the bond such as resin reduces the density of the magnet, causing a reduction in residual magnetic flux density.

In JP 2012-69962 A and JP 2005-223263 A, the magnetic particles are not sintered, and thus, gaps remain between particles of the powder in the molded magnet. In other words, the molded magnet of unsintered magnetic powder has lower density than the molded magnet of sintered magnetic powder. As a result, the molded magnet of the unsintered magnetic powder has lower residual magnetic flux density than that of the sintered magnetic powder.

In JP 2015-8200 A, which describes a technique dealing with the above-described problem, when the primary molding has a complicated shape, a high pressurizing pressure cannot be applied depending on the configuration of the mold. In other words, an increase in density is limited depending on the shape of the molding. Then, enhancement of the residual magnetic flux density of the manufactured magnet is also limited.

### SUMMARY OF THE INVENTION

An object of the invention is to provide a magnet manufacturing method and a magnet that allow a high residual magnetic flux density to be obtained without the use of a bond.

A magnet manufacturing method according to an aspect of the invention includes preparing magnetic powder of a hard magnetic material, which includes one or more of an Fe-N-based compound and an R-Fe-N-based compound (R: rare earth element),
pressurizing and molding the magnetic powder at a pressure equal to or higher than a fracture pressure at which particles of the magnetic powder are destroyed in order to obtain a primary molding, and
heating the primary molding at a temperature lower than a decomposition temperature of the magnetic powder.

For the magnetic powder, in a particle size distribution, a ratio (D50/D3) of a particle size with a cumulative frequency of 50% (D50) to a particle size with a cumulative frequency of 3% (D3) is less than eight.

In the magnet manufacturing method according to this aspect, a compound that includes one or more of the Fe-N-based compound and the R-Fe-N-based compound (R: rare earth element) is used as the magnetic powder of the hard magnetic material. Thus, a magnet can be inexpensively manufactured.

In the preparation of the magnetic powder of the hard magnetic material in the manufacturing method according to this aspect, the magnetic powder is prepared for which a particle size distribution measured for the magnetic powder indicates that a D50/D3 ratio of the magnetic powder is less than eight. For this magnetic powder, when the magnetic powder is subsequently pressurized at a pressure equal to or higher than a fracture pressure in order to obtain the primary molding, the particles of the magnetic powder are destroyed. The destruction occurs when each of the particles of the magnetic powder imposes a heavy load on (applies a high pressure to) another particle. The particle of the magnetic powder (another particle) is destroyed into crushed particles. Further pressurization causes the crushed particles to be moved (rearranged). As a result, a dense primary molding with reduced gaps is obtained.

The primary molding is heated to join surfaces of the particles of the magnetic powder together to form a secondary molding. The secondary molding is configured such that the magnetic powder particles are joined together in the dense primary molding with the filled gaps.

As described above, the manufacturing method according to this aspect allows manufacture of a dense magnet with filled gaps.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating steps of a magnetic manufacturing method in a first embodiment;

FIG. 2 is a diagram illustrating a relationship between a particle size distribution ratio and a molding density ratio in the first embodiment;

FIG. 3 is a schematic diagram illustrating a mixing step for magnetic powder and a lubricant in the first embodiment;

FIG. 4 is a schematic diagram illustrating the mixing step for the magnetic powder and the lubricant in the first embodiment;

FIG. 5 is a schematic diagram illustrating a pressurizing step for the magnetic powder and the lubricant in the first embodiment;

FIG. 6 is a schematic diagram illustrating the pressurizing step for the magnetic powder and the lubricant in the first embodiment;

FIG. 7 is a diagram illustrating a relationship between the number of pressurizations and the density ratios of moldings in the first embodiment;

FIG. 8 is an enlarged photograph of a molding of magnetic powder A;

FIG. 9 is an enlarged photograph of a molding of magnetic powder C; and

FIG. 10 is a diagram illustrating changes in a heating temperature for a heat treatment step in the first embodiment.

### DETAILED DESCRIPTION OF EMBODIMENTS

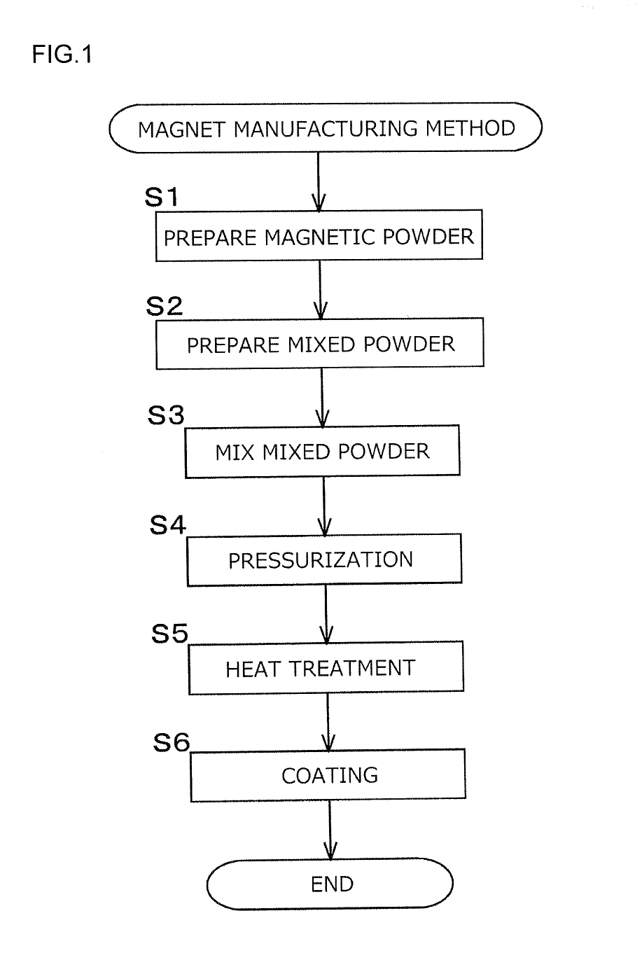

A magnet manufacturing method according to the invention will be described as an embodiment with reference to FIGS. 1 to 10. FIG. 1 is a diagram illustrating steps of the magnet manufacturing method of a first embodiment.

As illustrated in step Si in FIG. 1, magnetic powder 1 of a hard magnetic material as a raw material for a magnet is prepared.

As the magnetic powder 1, a compound is used which includes one or more of an Fe-N-based compound and an R-Fe-N-based compound. A rare earth element represented by R is preferably an element that is known as a so-called rare earth element and that is other than Dy. In particular, light rare earth elements are preferable, and among the light rare earth elements, Sm is suitable. The light rare earth elements described herein refer to elements included in lanthanoids and each having a smaller atomic weight than Gd, that is, La, Ce, Pr, Nd, Pm, Sm, and Eu. A specific composition of the magnetic powder 1 is not limited as long as the magnetic powder 1 is an Fe-N-based compound or an R-Fe-N-based compound. Powder of Sm₂Fe₁₇N₃ or Fe₁₆N₂ is suitably used.

The magnetic powder 1 may be formed of powder with the same composition or may be formed by mixing powder with different compositions together. Preferably, the magnetic powder 1 is formed of powder with the same composition.

A particle size distribution measured for the magnetic powder 1 prepared indicates that, for the magnetic powder 1, the ratio (D50/D3) of a particle size with a cumulative frequency of 50% (D50) to a particle size with a cumulative frequency of 3% (D3) is less than eight. A method for measuring the particle size distribution is not limited, and a measurement method (calculation method) may be used which allows the particle size and the frequency to be understood.

The magnetic powder 1 in the present embodiment is magnetic powder having a D50/D3 ratio of less than eight. The magnetic powder 1 has only a short interval between D50 and D3. That is, a particle size distribution curve shows a sharp peak. More specifically, the magnetic powder 1 in the present embodiment involves only a minor variation in particle size and thus has a relatively uniform particle size.

The magnetic powder 1 preferably has an average particle size of approximately 2 μm to approximately 5 μm. The use of a hard magnetic material that needs no Dy allows a magnet to be inexpensively manufactured. For the magnetic powder 1 used, an oxide film is not formed all over the surface of the magnetic powder 1.

As described above, in the present embodiment, a particle size distribution characteristic of the magnetic powder 1 is specified based on the D50/D3 ratio. This specification is made for the reason described below.

First, magnetic powders A, B, and C having particle size distribution characteristics indicated in Table 1 were prepared. The magnetic powder A corresponds to the embodiment of the invention, and the magnetic powders B and C correspond to conventional examples (comparative examples).

TABLE 1

| Particle size distribution | | Magnetic | Magnetic |
|---|---|---|---|
| characteristic | Magnetic powder A | powder B | powder C |
| D50 (μm) | 3.11 | 3.28 | 3.19 |
| D1 (μm) | 0.40 | 0.42 | 0.24 |
| D50/D1 | 7.8 | 7.8 | 13.3 |
| D3 (μm) | 0.88 | 0.72 | 0.31 |
| D50/D3 | 3.5 | 4.6 | 10.3 |
| D10 (μm) | 1.61 | 1.50 | 1.40 |
| D50/D10 | 1.9 | 2.2 | 2.3 |
| Molding density ratio (%) | 106.90 | 103.40 | 100.00 |

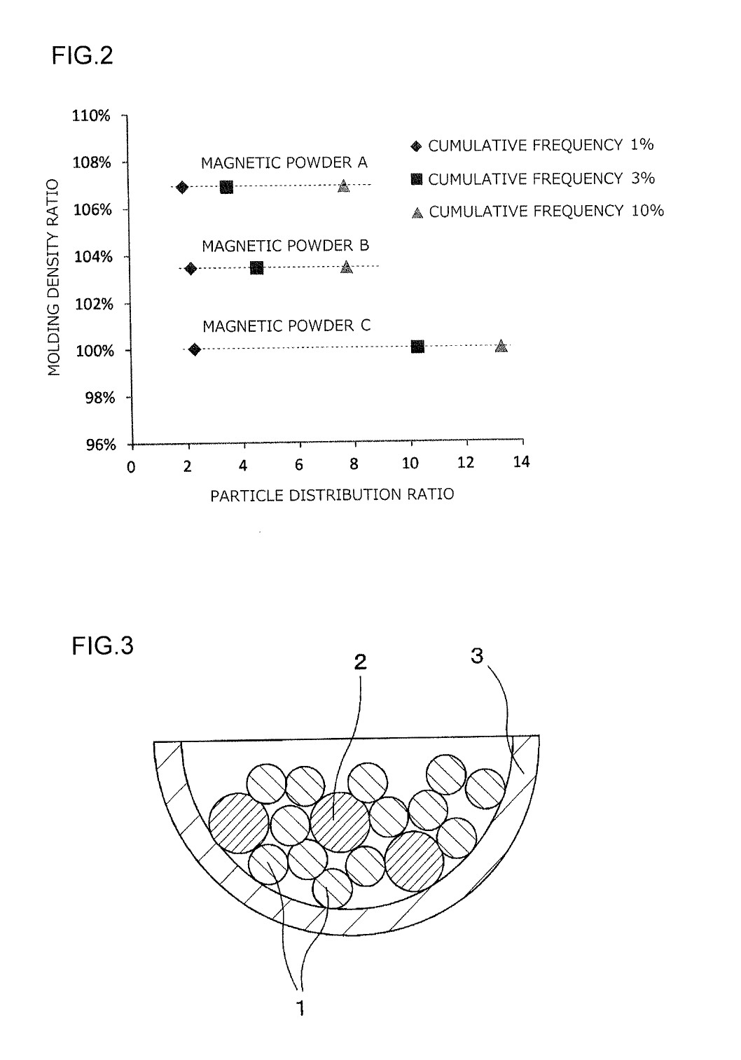

Steps 1 to 4 illustrated in FIG. 1 were executed on the magnetic powders A to C to obtain primary moldings by pressure molding. Molding conditions were such that pressurization was performed 80 times at an applied pressure of 1.5 GPa. The densities of the primary moldings were measured, and the results are indicated in both Table 1 and FIG. 2. In Table 1, the density of each of the moldings is indicated as the density ratio of the molding to a molding of the magnetic powder C. FIG. 2 illustrates a relationship between a particle size distribution ratio and a molding density ratio. The particle size distribution ratio is a value determined from D50/D1, D50/D3, or D50/D10.

As indicated in Table 1, a molding with a density ratio of 106.9% was manufactured from the magnetic powder A, and a molding with a density ratio of 103.4% was manufactured from the magnetic powder B.

As indicated in FIG. 2 and Table 1, a molding with the highest density can be manufactured from the magnetic powder A with a D50/D3 ratio of less than eight.

In a comparison between the magnetic powder A and the magnetic powder B, the magnetic powders A and B have the same D50/D1 ratio and different molding densities. This also applies to the values of the D50/D10 ratio. This indicates that pressure molding of a dense primary molding can be achieved by specifying the particle size distribution characteristic of the magnetic powder 1 based on the D50/D3 ratio.

As illustrated in step S2 in FIG. 1, the magnetic powder 1 prepared in step S1 and a lubricant 2 (solid lubricant powder) that is powdery at normal temperature are prepared.

Metal soap powder is used as the lubricant 2. As the lubricant 2, powder of stearic acid-based metal such as zinc stearate is used. The particle size (average particle size: D50) of the lubricant 2 is not limited but may be approximately 10 μm. In other words, the lubricant 2 has a larger average particle size than the coarse powder 12 in the magnetic powder 1. The lubricant 2 has a smaller specific gravity than the magnetic powder 1. Setting a somewhat large initial size for the lubricant 2 enables each particle of the lubricant 2 to have a large mass. This prevents the lubricant 2 from being stirred up in step S3 described below when the lubricant 2 is mixed with the magnetic powder 1.

As illustrated in step S3 in FIG. 1, the magnetic powder 1 and the lubricant 2 prepared in the step S2 are mixed together while being ground.

A mixture ratio between the magnetic powder 1 and the lubricant 2 can be optionally set. The preferable mixture ratio between the magnetic powder 1 and the lubricant 2 is such that, in volume percentage, the magnetic powder is 80 to 90 vol %, whereas the lubricant 2 is 5 to 15 vol %. Besides the magnetic powder 1 and the lubricant 2, an additive may be added. Examples of the additive include organic solvents that disappear as a result of subsequent heating.

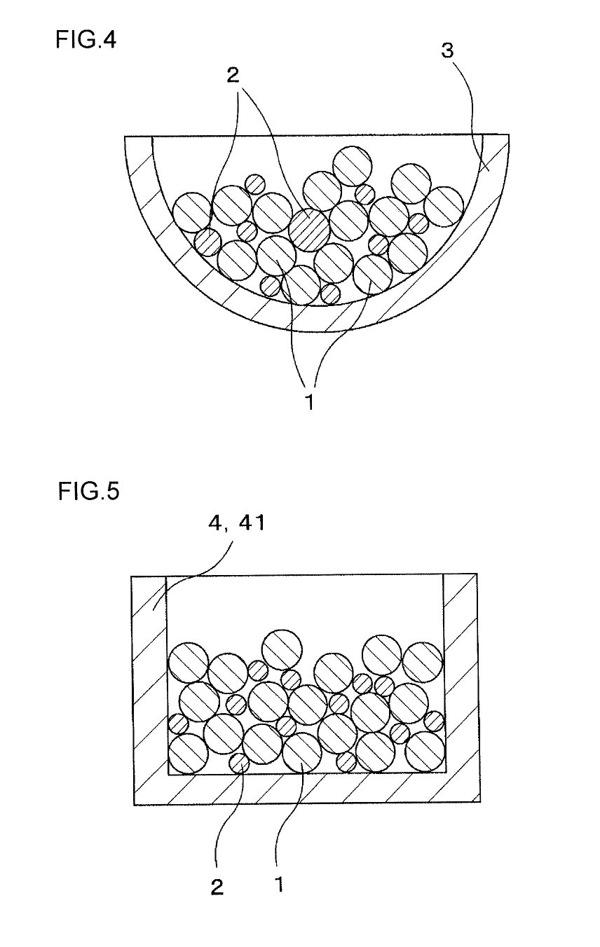

Any method may be used to mix the magnetic powder 1 and the lubricant 2 together as long as the method allows the magnetic powder 1 and the lubricant 2 to be mixed together while being ground. For example, in a mixture container 3, the magnetic powder 1 and the lubricant 2 are mixed together while being ground as depicted in a schematic diagram in FIG. 3. Mixing and simultaneously grinding the magnetic powder 1 and the lubricant 2 fractionizes the lubricant 2, which has a low joining strength, to reduce the general particle size of the lubricant 2, as depicted in a schematic diagram in FIG. 4. Thus, particles of the lubricant 2 present at the end of the mixing step have different particle sizes.

During the mixture of the magnetic powder 1 and the lubricant 2, grinding is performed at a pressure at which the magnetic powder 1 is prevented from being destroyed.

At the end of the mixing step, the mixed powder of the magnetic powder 1 and the lubricant 2 can contain reduced massive portions formed only of the magnetic powder 1 and have a reduced particle size of the lubricant 2. In other words, fine particles of the lubricant 2 resulting from crushing can be present at positions proximate to each particle of the magnetic powder 1.

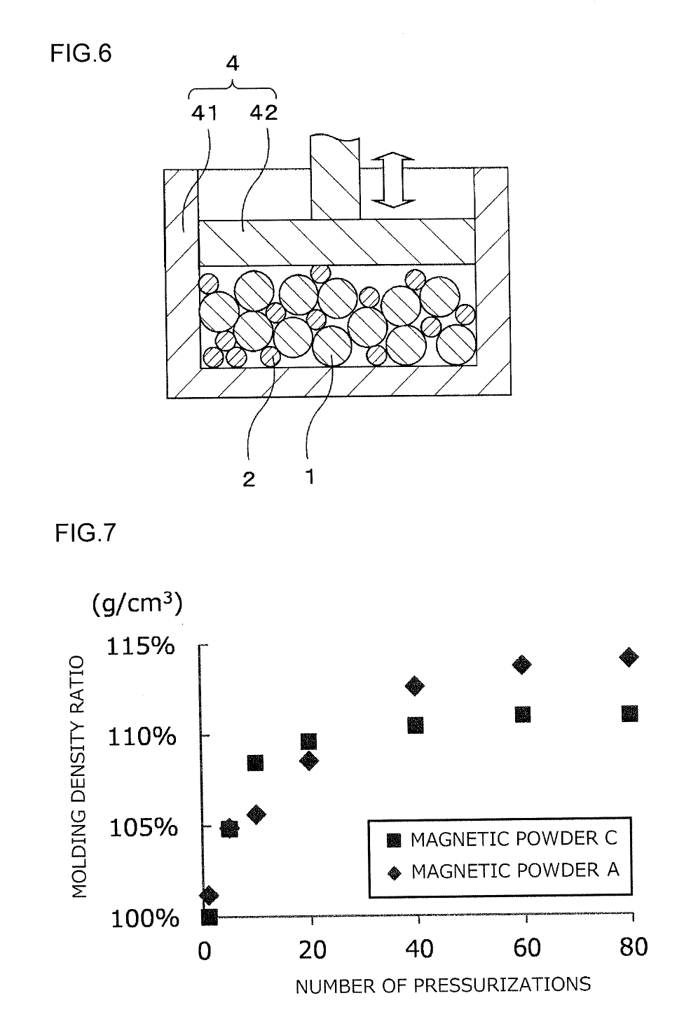

Subsequently, as illustrated in step S4 in FIG. 1, the mixed powder of the magnetic powder 1 and the lubricant 2 is pressurized to form a primary molding 5 (FIG. 5 and FIG. 6).

In the pressurizing sep, as depicted in a schematic diagram in FIG. 5, the mixed powder of the magnetic powder 1 and the lubricant 2 is fed into a cavity in a pressurizing mold 4 (pressurizing lower mold 41 (mold)).

As depicted in a schematic diagram in FIG. 6, a pressurizing upper mold 42 (mold) is assembled into the pressurizing lower mold 41 and moved in a direction in which the pressurizing upper mold 42 approaches the pressurizing lower mold 41. Thus, the mixed powder is molded under pressure using the pressurizing mold 4 (41 and 42). At this time, a pressure applied by the pressurizing mold 4 (41 and 42) is a pressure equal to or higher than a fracture pressure at which the magnetic powder 1 in the mixed powder of the magnetic powder 1 and the lubricant 2 is destroyed. In the present embodiment, the applied pressure is 1 GPa to 3GPa.

In the present embodiment, the pressurization with the pressurizing mold 4 causes the particles of the magnetic powder 1 to be destroyed. In this case, one particle (first particle) of the magnetic powder 1 transmits a load (applied pressure) to another particle (second particle), and the second particle, subjected to the load equal to or higher than the fracture pressure, is destroyed. The second particle is then formed into fine crushed particles.

When further pressurized, the fine crushed particles into which the second particle has been crushed are shifted and rearranged.

As described above, in the pressurizing step (S4) in the present embodiment, the magnetic powder 1 is pressurized at a pressure equal to or higher than the fracture pressure at which the magnetic powder 1 is destroyed. The magnetic powder 1 is thus destroyed and rearranged into a dense primary molding 5.

When having a D50/D3 ratio of eight or more, the magnetic powder 1 has significantly varying particle sizes. In particular, magnetic powder having significantly varying particle sizes contains a large number of fine particles. For such magnetic powder, even with the pressurization in the pressurizing step (S4), movement of the fine particles inhibits the applied pressure from being transmitted to particles with relatively large particle sizes. Furthermore, the area of contact between coarse particles is limited, leading to concentration of the pressure. In contrast, when the coarse particles are pressurized using fine particles, a large number of the fine particles pressurize the coarse particles to increase the area of contact so that the coarse particles are not pressurized at a pressure equal to or higher than the fracture pressure. As a result, a coarse primary molding is obtained.

Pressurization with the pressurizing mold 4 (41 and 42) is performed a plurality of times (twice or more). After a pressure is applied to the pressurizing upper mold 42, the pressure applied to the pressurizing upper mold 42 is weakened, and then, a pressure is applied to the pressurizing upper mold 42 again. Then, this operation is repeated. To weaken the pressure applied to the pressurizing upper mold 42, the pressurizing upper mold 42 may be moved upward or only the applied pressure may be reduced without upward movement of the pressurizing upper mold 42.

Pressurization with the pressurizing mold 4 (41 and 42) is performed a plurality of times, and an upper limit on the number of pressurizations may be equal to or higher than the number of pressurizations resulting in saturation of the effect of an increase in the density of the primary molding. For example, the pressurization may be performed 80 times or more.

As described above, in the pressurizing step in the present embodiment, the number of pressurizations in the pressurizing step may be equal to or larger than the number of pressurizations resulting in saturation of the effect of an increase in the density of the primary molding. This specification is made for the following reason.

The above-described magnetic powder A and magnetic powder C were prepared.

Steps S1 to S4 illustrated in FIG. 1 were executed on the magnetic powder A and the magnetic powder C to mold the magnetic powders A and C under pressure into primary moldings. The applied pressure for molding was 1.5 GPa. The densities of the moldings were measured when the number of pressurizations reached 1, 5, 10, 20, 40, 60, and 80, and the results are indicated in FIG. 7 and Table 2. The density of each of the moldings in Table 2 is represented as a density ratio with respect to a molding resulting from one pressurization of the magnetic powder C.

TABLE 2

| | Molding density ratio (%) | |
|---|---|---|
| The number of pressurizations | Magnetic powder A | Magnetic powder C |
| 1 | 101.2 | 100.0 |
| 5 | 104.9 | 104.8 |
| 10 | 105.6 | 108.5 |
| 20 | 108.5 | 109.6 |
| 40 | 112.6 | 110.4 |
| 60 | 113.7 | 111.0 |
| 80 | 114.0 | 110.9 |

As depicted in FIG. 7 and Table 2, for both moldings of the magnetic powders A and C, the density of the molding increases with an increase in the number of pressurizations.

FIG. 7 and Table 2 indicate that the rate of increase in the density of the molding (density increase effect) decreases after the number of pressurizations exceeds 40. The density increase effect is substantially saturated when the number of pressurizations reaches and exceeds 60.

Thus, 80 or more pressurizations enable pressure molding of a dense primary molding.

In the pressurizing step, the pressurizing mold 4 (41 and 42) is heated at an outer side surface thereof using a heater (not depicted in the drawings) to heat the mixed powder of the magnetic powder 1 and the lubricant 2. A heating temperature T₁ for the mixed powder of the magnetic powder 1 and the lubricant 2 is lower than a decomposition temperature of the magnetic powder 1 and equal to or higher than a melting point T₃ of the lubricant 2 (T₃≦T₁<T₂). Therefore, the magnetic powder 1 is not decomposed even on heating. The lubricant 2, which is solid (powdery) at normal temperature, becomes a liquid during the pressurizing step because the lubricant 2 is heated at the melting point thereof or higher.

In this manner, while the magnetic powder 1, contained in the mixed powder of the magnetic powder 1 and the lubricant 2, is being pressurized, the lubricant 2 becomes a liquid instead of a solid and has a viscosity corresponding to the temperature. The viscosity of the lubricant 2 decreases with an increase in the heating temperature T₁. The liquid lubricant 2 adheres to the entire surface of each of the particles of the magnetic powder 1 without being segregated.

Repeated pressurizations allow crushed particles to be rearranged between the particles of the magnetic powder 1 to form a primary molding 5 with reduced gaps between the particles of the magnetic powder 1. This is because a plurality of pressurizations allows rearrangement of the particles of the magnetic powder 1 and the crushed particles with respect to the arrangement of the particles of the magnetic powder 1 resulting from the last pressurization.

In the pressurizing mold 4, the liquid lubricant 2 is interposed between the adjacent particles of the magnetic powder 1 to allow the particles of the magnetic powder 1 to move smoothly. The gaps between the particles of the magnetic powder 1 in the primary molding 5 are reduced by synergetic action of rearrangement of the particles of the magnetic powder 1 and sliding of the particles of the magnetic powder 1 due to the lubricant 2.

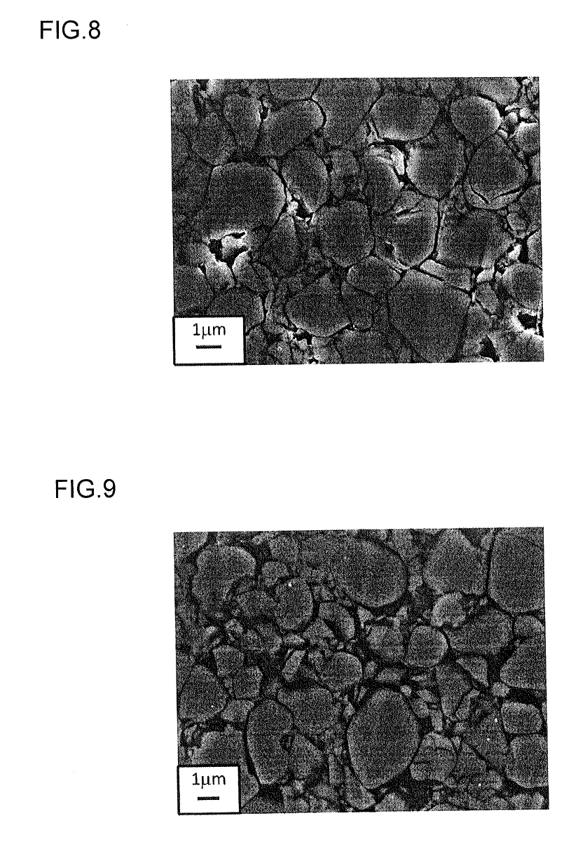

In the primary molding 5 obtained in the pressurizing step, the particles of the magnetic powder 1 are destroyed and the resultant particles are densely rearranged as depicted in FIG. 8. Thus, the gaps between the particles are filled to form a dense molding. FIG. 8 is an SEM photograph of a molding formed of the magnetic powder A.

FIG. 9 depicts an SEM photograph of a molding formed of the magnetic powder C. As depicted in FIG. 9, in the molding formed of the magnetic powder C, small particles of the magnetic powder were arranged around particles of the magnetic powder having large particle sizes. FIG. 9 depicts more gaps between the particles than FIG. 8.

As depicted in FIGS. 8 and 9, a dense molding can be manufactured in the example corresponding to the embodiment of the invention.

As illustrated in step S5 in FIG. 1, the primary molding 5 is heated in an oxidizing atmosphere to form a secondary molding (heat treatment step).

Heating the primary molding 5 in the oxidizing atmosphere causes exposed surfaces of the particles of the magnetic powder 1 to react with oxygen to generate an oxide film on the surface of each of the particles of the magnetic powder 1. The oxide film joins the surfaces of the adjacent particles of the magnetic powder 1. The oxide film is formed on a portion of each particle of the magnetic powder 1, which is exposed to the gap, while a base material with no oxide film formed thereon is present in a portion of each particle of the magnetic powder 1, which is not exposed to the gap (the interface at which the particle of the magnetic powder 1 is compressed against the adjacent particle of the magnetic powder 1). Therefore, the oxide film is not formed all over the surface of each particle of the magnetic powder 1.

The secondary molding thus formed has a sufficient strength. This enables an increase in a flexural strength of the secondary molding. Moreover, in the pressurizing step, areas of the primary molding 5 where no magnetic powder 1 is present are reduced, enabling an increase in residual magnetic flux density of the secondary molding resulting from the heat treatment step. The secondary molding has a density of approximately 5 to 6 g/cm³.

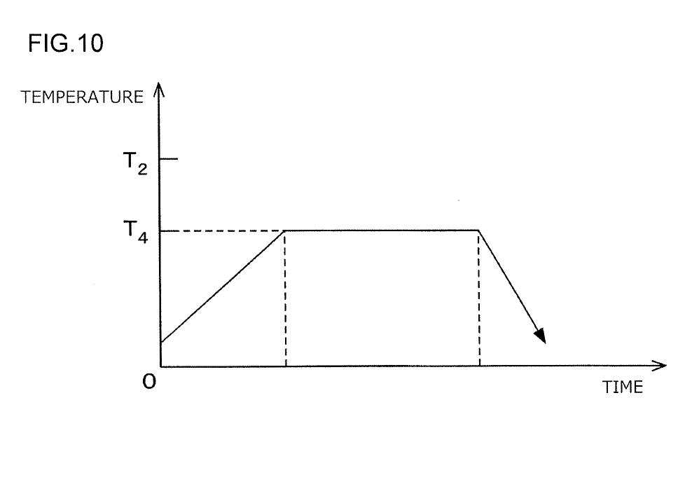

The heat treatment step is executed with the primary molding 5 placed in a microwave heating furnace, an electric furnace, a plasma heating furnace, a high-frequency quenching furnace, a heating furnace with an infrared heater, or the like. The heating during the heat treatment step is not limited but may be performed so as to go through temperature changes depicted in FIG. 10.

As depicted in FIG. 10, a heating temperature T₄ is set lower than the decomposition temperature T₂ of the magnetic powder 1. For example, when Sm₂Fe₁₇N₃ or Fe₁₆N₂ is used as the magnetic powder 1, the heating temperature T₄ is set lower than 500° C. because the decomposition temperature T₂ of Sm₂Fe₁₇N₃ or Fe₁₆N₂ is approximately 500° C. For example, the heat treatment temperature T₄ in the heat treatment step is approximately 200 to 300° C.

An oxygen concentration and an atmospheric pressure in the oxidizing atmosphere may be set to any values as long as the oxygen concentration and the atmospheric pressure allow the magnetic powder 1 to be oxidized. An oxygen concentration and an atmospheric pressure equal or close to the oxygen concentration and the atmospheric pressure in the air are sufficient for this purpose. Therefore, special management of the oxygen concentration and the atmospheric pressure is not needed. The heating may be performed in the aerial atmosphere. Setting the heating temperature T₄ at approximately 200 to 300° C. allows an oxide film to be formed regardless of whether the magnetic powder is Sm₂Fe₁₇N₃ or Fe₁₆N₂.

As illustrated in step S6 in FIG. 1, a treatment is executed in which the surface of the secondary molding formed in the heat treatment step is covered with a coating film, to form a tertiary molding.

Examples of the coating film for the tertiary molding include a plating film formed by electroplating of Cr, Zn, Ni, Ag, Cu, or the like, a plating film formed by electroless plating, a resin film formed by resin coating, a glass film formed by glass coating, and a film formed of Ti, diamond-like carbon (DLC), or the like. Examples of the electroless plating include electroless plating using Ni, Au, Ag, Cu, Sn, Co, or an alloy or a mixture thereof. Examples of the resin coating include coating with a silicone resin, a fluorine resin, a urethane resin, or the like.

The coating film formed on the tertiary molding functions like an egg shell. The tertiary molding can have an increased flexural strength as a result of a joining force exerted by the oxide film and the coating film. In particular, the electroless plating enables surface hardness and adhesion to be enhanced and allows the joining force of the magnetic powder 1 to be made stronger. Furthermore, for example, electroless nickel-phosphorous plating offers high corrosion resistance.

As described above, the oxide film joins the particles of the magnetic powder 1 together not only on the surface of the secondary molding but also inside the secondary molding. The joining force of the oxide film regulates free movement of the particles of the magnetic powder 1 inside the tertiary molding. This suppresses inversion of magnetic poles resulting from rotation of the magnetic powder 1. A high residual magnetic flux density can be achieved.

When the electroplating is applied in the coating step, the unplated secondary molding acts as an electrode. Thus, the secondary molding needs to have a high joining strength. However, when the electroless plating, the resin coating, or the glass coating is applied in the coating step, the joining strength of the secondary molding need not be so high as the joining strength needed for the secondary molding when the electroplating is applied. The joining force resulting from the oxide film is sufficient. Therefore, the coating step as described above allows the coating film to be reliably formed on the surface of the secondary molding.

When the electroless plating is applied in the coating step, the secondary molding is immersed in a plating solution. At this time, the plating solution acts to enter the inside of the secondary molding. However, the oxide film formed on the secondary molding effectively suppresses the entry of the plating solution. This is expected to inhibit possible corrosion of the secondary molding or the like resulting from the entry of the plating solution into the inside of the secondary molding.

In the manufacturing method of the present embodiment, a compound that includes one or more of an Fe-N-based compound and an R-Fe-N-based compound (R:

rare earth element) is used as the magnetic powder 1 of the hard magnetic material. Thus, a magnet can be inexpensively manufactured.

The manufacturing method in the present embodiment allows avoidance of the use of dysprosium (Dy) as R. Therefore, a magnet can be inexpensively manufactured.

In the step of preparing the magnetic powder 1 of the hard magnetic material (step Si) in the manufacturing method according to the present embodiment, the magnetic powder 1 is prepared for which a particle size distribution measured for the magnetic powder 1 indicates that the D50/D3 ratio of the magnetic powder 1 is less than eight. When the magnetic powder 1 is pressurized at a pressure equal to or higher than the fracture pressure in the subsequent step of obtaining the primary molding 5 (step S4), the particles of the magnetic powder 1 are destroyed. The destruction occurs when each of the particles of the magnetic powder 1 imposes a heavy load on (applies a high pressure to) another particle. The particle of the magnetic powder (another particle) is destroyed into crushed particles. Further pressurization causes the crushed particles to be moved (rearranged). As a result, a dense primary molding 5 with reduced gaps is obtained.

The primary molding 5 is heated to join surfaces of the particles of the magnetic powder 1 together to form a secondary molding. The secondary molding is configured such that the magnetic powder particles are joined together in the dense primary molding with the filled gaps.

The manufacturing method according to the present embodiment allows manufacture of a dense magnet with filled gaps.

In the pressurizing step (step S4) in the manufacturing method according to the present embodiment, pressurization is performed a plurality of times. Performing a plurality of pressurizations causes the particles of the magnetic powder 1 to be destroyed and rearranged. Thus, a dense primary molding 5 with filled gaps is obtained.

In the manufacturing method according to the present embodiment, the solid lubricant powder 2 is mixed with the magnetic powder 1. Consequently, the pressurization in the pressurizing step (step S4) facilitates movement of the fine powder 11 to the gaps between the particles of the coarse powder 12. That is, the dense primary molding 5 with filled gaps is obtained.

In the heat treatment step (step S5) of heating the primary molding 5 in the manufacturing method according to the present embodiment, the primary molding 5 is heated at a temperature equal to or higher than the melting point T₃ of the lubricant 2. Consequently, the lubricant 2 is placed on the surface of each of the particles of the magnetic powder 1 forming the primary molding 5.

What is claimed is:

1. A magnet manufacturing method comprising:
preparing magnetic powder of a hard magnetic material that includes one or more of an Fe-N-based compound and an R-Fe-N-based compound;
pressurizing and molding the magnetic powder at a pressure equal to or higher than a fracture pressure at which particles of the magnetic powder are destroyed in order to obtain a primary molding, and
heating the primary molding at a temperature lower than a decomposition temperature of the magnetic powder; wherein
for the magnetic powder, in a particle size distribution, a ratio (D50/D3) of a particle size with a cumulative frequency of 50% (D50) to a particle size with a cumulative frequency of 3% (D3) is less than eight.

2. The magnet manufacturing method according to claim 1, wherein
the pressurization is performed a plurality of times.

3. The magnet manufacturing method according to claim 1, wherein
the magnetic powder is mixed with powder of solid lubricant.

4. The magnet manufacturing method according to claim 1, wherein
in the heating of the primary molding, the primary molding is heated at a temperature equal to or higher than a melting point of the solid lubricant.

5. A magnet manufactured by the manufacturing method according to claim 1.
